(19) United States
(12) Patent Application Publication
(10) Pub. No.: US 2008/0271120 A1
(43) Pub. Date: Oct. 30, 2008

(54) Network Pre-Authentication

(75) Inventors: Daniel Parkes, San Francisco, CA (US); Anne Bezancon, Oakland, CA (US)

Correspondence Address: SF Bay Area Patents, LLC;Attn: Andrew V. Smith, Ph.D., 601 Van Ness Avenue, #1108, San Francisco, CA, 94102, US

(73) Assignee: 1020, INC., San Francisco, CA (US)

(21) Appl. No.: 12/108,504

(22) Filed: Apr. 23, 2008

Related U.S. Application Data
(60) Provisional application No. 60/913,451, filed on Apr. 23, 2007.

(30) Foreign Application Priority Data
Apr. 23, 2008 (US) PCT/US2008/061356

(51) Int. Cl. H04L 9/00

(52) U.S. Cl. 726/3

(57) ABSTRACT

A method of dynamic pre-authentication includes receiving at an access point from one or more content platforms a white-list of internet domains that are to be deemed valid for serving content to a non-authenticated user. Updates to the white list are dynamically received from the one or more content platforms which are each responsible for a particular promotional campaign that features specific content. A request is received at the access point from a non-authenticated user for certain of the specific content, which is allowed such that a domain of the content platform responsible for the certain specific content is accessed by the user.

### PRIORITY

This application claims the benefit of priority to U.S. provisional patent application No. 60/913,451, filed Apr. 23, 2007, which is incorporated by reference.

### BACKGROUND OF THE INVENTION

1. Field of the Invention

The present invention relates to publishing content via a Wireless Access Point to a User over the internet.

2. Description of the Related Art

A traditional online advertising campaign is illustrated in FIG. 1. An Advertiser 11 may wish to promote a product or service on the internet. For example, Nike™ may wish to promote a brand of shoes to a specific demographic. An advertising agency 12, for example Ogilvy™ may be available to assist (Nike™) in the process of building an effective advertising campaign, including the creation of content and the selection of networks to publish the content. Traditional online ad servers 13, for example Doubleclick™, serve the content and perform performance tracking and reporting.

Internet users typically have to pay for internet access. Oftentimes, the user will have a subscription to be paid periodically. In other cases, internet users will pay for internet access each time they log-in, e.g., at an internet cafe or a hotel. A user who has paid the requisite fees will be authenticated when he or she attempts to access the internet, and will thereby be allowed access. However, a user who has not paid the requisite fees, will have displayed on his or her computer simply a single page or a few pages providing instructions on how to pay such fee while no other page will be accessible until the fee is paid.

A User may submit a request to access the Internet via a Wireless Access Point or Ethernet or other wired connection to an access point. In many cases, the Operator of the Access Point (known as the Network Operator) wishes to control whether a request may be processed successfully or whether it should be blocked.

There are many Business Rules that may be applied by the Network Operator in order to determine whether a request by a User is to be successfully processed. For example, the Network Operator may allow a User to make requests to some servers but not to others. A Network Operator may require that a User be authenticated before allowing access or a User may be required to pay a fee before allowing a request to be processed successfully. Even once a User has been authenticated, there may be restrictions that limit the number of requests that a User may submit, or a time limit on the length of a User session.

In a typical scenario, when a User first makes a request to the Internet via the Access Point, the request is blocked and a Splash page is presented. Either on the Splash page, or on another page, the User either is or is not able to supply the necessary authentication credentials. There may be a Login page where a User could submit a User Name and Password combination or there may some other authentication technique by which the User is authenticated, e.g., with a card key or fingerprint scan. In any case, there may be a set of one or more pre-authenticated pages that may be managed by the Network Operator. Those pages will be the only ones that may be displayed to a User without authentication.

Displaying a page before a User has been authenticated becomes an issue when trying to display pages that are composed of many heterogeneous content elements. For example, a Network Operator may want to increase the return on investment for an Access Point installation by displaying advertisements along with other content on their Pre-Authenticated pages. Advertisements are typically served by a different provider than the Network Operator. As the User is not yet authenticated, the Network Operator must explicitly allow the advertisement requests to be completed successfully.

It is desired to have an efficient way of dynamically providing pre-authenticated content to a non-authenticated user.

### Static Walled-Garden

A Network Operators may use a Walled-garden which may be constructed as part of Network Operator software and allows certain content to be fetched without User authentication. The problem, however, is that a Walled-garden is not desirable as a scaleable solution. For one thing, content to be allowed for a new advertiser is manually added to the Walled-garden. Network Operator software often involves this be done per Access Point, thus making Network-wide configuration changes very tedious. Further, content typically links to other content on the Internet. This linked content can be from anywhere as it is not yet controlled by the Walled-garden, thus when one of the links is clicked it often gets blocked. In the case of certain advertisers, this may be an unacceptable restriction.

Walled-gardens may be viewed as implementations “white-lists”. A white-list includes a set of entities or other things that are explicitly allowed to do something. In the case of a Walled-garden, the set of things may be internet domains. The domains may be expressed in full (e.g. placecast.net) or as a regular expression that allows for all sub-domains of a primary domain to be treated the same way (e.g. *.placecast.net).

### Content Transformation

Network Operators may use software and/or hardware that transforms the content as it is delivered to the User, thus providing fine-grained control over which content is allowed and which content is blocked. A problem is that this is limited to the particular network that runs that hardware and software combination. In practice, there may be many different implementations of Access Points and it is desired to have a more general solution.

U.S. Pat. No. 6,487,538, which is hereby incorporated by reference, describes a concept referred to as proxying, or inserting hardware/software in-between the user and the content server. With a proxy, requests can be analyzed and/or modified based on their content. Existing content transformation solutions do exactly this. Some companies that are relevant include AdZilla and Perftech (see, e.g., U.S. Pat. No. 7,328,266, incorporated by reference). It is desired to have a system that does not require this proxy solution in a hardware form, even though an intermediary may act when fetching content from third party ad servers.

### SUMMARY OF THE INVENTION

A method of dynamic pre-authentication is provided. The method includes receiving at an access point from one or more content platforms a white-list of internet domains that are to be deemed valid for serving content to a non-authenticated user. Updates to the white list are dynamically received from the one or more content platforms which are each responsible for a particular promotional campaign that features specific content. A request is received at the access point from a non-authenticated user for certain of the specific content. The non-authenticated user is allowed to retrieve a domain of the content platform responsible for the certain specific content.

The request may be for ad content available via an Ad Server. The response may be provided to the user from the Ad Server including the ad content.

The method may further include receiving and allowing a click request from the user in regard to the ad content. The response page may be provided to the user based on requests to the Ad Server and to an Advertiser web site responsible for the response page.

The method may further include receiving and allowing a request for an embedded image on the response page. The embedded image may be provided to the user based on a request to the Advertiser web site.

The method may further include receiving and allowing a request for a link allowing user interaction at the Advertiser web site.

A method of implicit pre-authentication is also provided. The method includes providing to an internet access point a white-list of internet domains that are to be deemed valid for serving content to a non-authenticated user requesting access. A protocol of curtailed internet access is provided for a non-authenticated user requesting access to a domain that is on the white list. A request is received at the access point from a non-authenticated user for a domain that is on the white list. The non-authenticated user is allowed to have curtailed internet access according to the protocol at least in order to retrieve the white-listed domain.

The protocol may include a limited temporal duration within which the allowed internet access of the non-authenticated user is constrained. The protocol may also include a limited number of http requests, such that the non-authenticated user is constrained both to the limited temporal duration and the limited number of http requests. The protocol may also just include a limited number of http requests.

The protocol may include a limited amount of downloading of content, a limited quantity of interaction with one or more other users, and/or a limited amount of streaming of content.

One or more computer readable media are also provided with digital code embedded therein for programming one or more processors to perform any of the methods described herein.

### BRIEF DESCRIPTION OF THE DRAWINGS

FIG. 1 illustrates a traditional online advertising campaign.

FIG. 2 illustrates hosted or third party content publishing in accordance with an embodiment.

FIG. 3 illustrates an implicit authentication method in accordance with a further embodiment.

FIG. 4 illustrates a dynamic walled garden is accordance with another embodiment.

FIG. 5 illustrates network processes involving pre-authentication in accordance with certain embodiments.

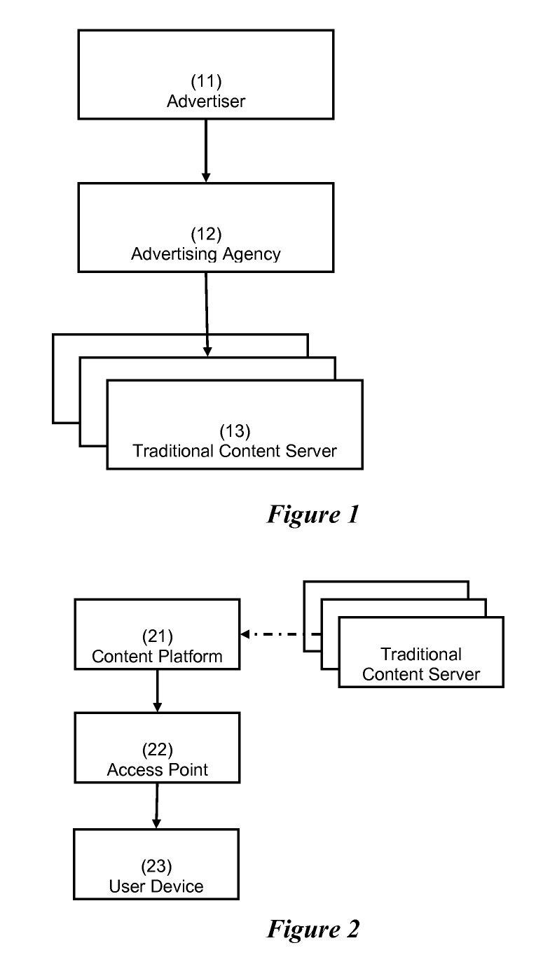

### DETAILED DESCRIPTION OF THE EMBODIMENTS

Several embodiments are described below. These embodiments include enhanced pre-authentication techniques.

### Hosted and/or Third-Party Content

The content that is part of the advertisement is either hosted on the advertising platform domain or is accessed using the platform as an intermediary, or both. We place one entry pointing to the advertising platform domain in the Walled-garden of the Network Operator. Content requests are then served either directly and/or indirectly from one domain, thus solving the scalability problem.

FIG. 2 illustrates hosted or third party content publishing in accordance with an embodiment. FIG. 2 shows content being served from a Content Platform 21, either directly or indirectly via traditional ad servers or traditional content servers. An Access Point 22 allows the request as the domain of the Content Platform is explicitly allowed by the Network Operator, e.g., in a walled garden. A User Device 23 receives the published content.

### Implicit Authentication

Authentication may be performed automatically using a specified set of credentials. The user may then be forwarded to the requested page without being otherwise authenticated. This allows subsequent content to be accessed successfully as it is now no longer blocked. In this embodiment, typically greater access to content is permitted compared with a walled garden, and even complete internet access may be granted as if the user has actually been authenticated.

This implied authentication is deemed reasonable from an advertising-perspective for several reasons. First, it does not need to be made known to the User that he or she has actually been implicitly authenticated. Second, the credentials may be configured in such a way that the User has access for a small amount of time or for a limited number of requests, or in accordance with another protocol of curtailment of access such as to a limited amount of downloading of content, a limited quantity of interaction with one or more other users, and/or a limited amount of streaming of content. Thus, an advertiser may be satisfied that general access to the network has not been fully provided to the user who has not officially been authenticated. Third, many users that view pre-authenticated pages might not actually log into the network. Thus, allowing clickable advertising on pre-authenticated pages can advantageously increase the amount of exposure.

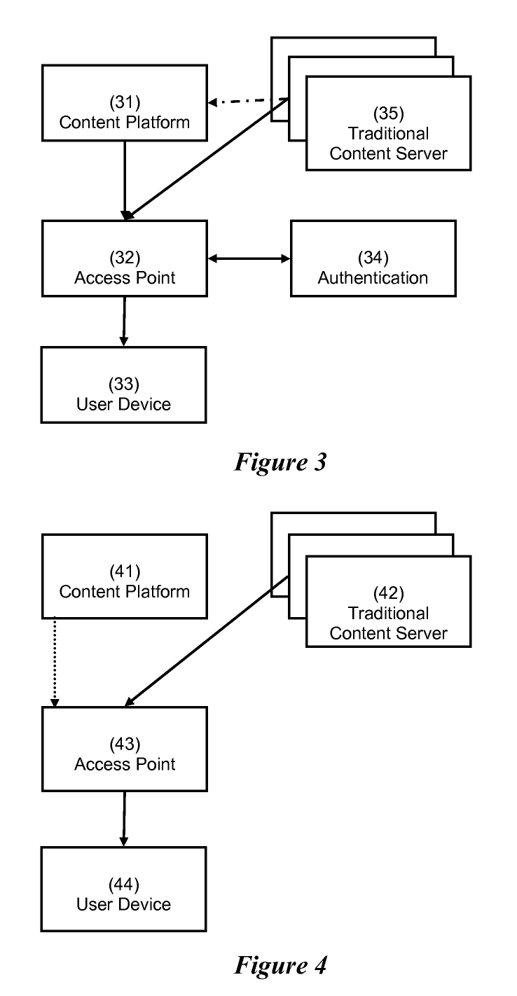

In general, software that interacts with the Internet via an Access Point may selectively display content in its user interface based on whether a User is authenticated. The embodiment of FIG. 3, while illustrated by example in the context Network Operators displaying web pages, is general enough to be implemented for any software that has an API for logging in a User programmatically. Referring to FIG. 3, initial content is served from a Content Platform 31, either directly or indirectly via traditional ad servers 35. Authentication info may be embedded for when content is clicked (or may be otherwise activated). The Access Point 32 allows the request as the domain of the Content Platform is explicitly allowed by the network operator, e.g., within a Walled-garden. A User Device 33 receives the published content. The user clicks (or otherwise activates) the content, which is not hosted by the content platform 31. In this embodiment, the user may be implicitly authenticated, and may become no longer restricted to domains that reside in the walled-garden. The user may receive the content from the unrestricted domain.

Automatic authentication may be performed by passing a specified set of credentials to the Network Operator's system at the same time a user clicks on a published advertising content or link thereto or otherwise executes a markup language object. Upon “behind-the-scenes” authentication, meaning that the User is given access to the Internet without pro-actively entering any credentials or at least without entering all of such credentials, the requested page corresponding to the advertisement is displayed to the User. All subsequent content may be now accessed successfully as it is now no longer blocked, although in accordance with this embodiment, subject to a protocol including one or more limitations.

In order to provide limited access to the advertiser's content and not allow the user to access the internet for free through the Operator's Network, the duration of the user session is constrained in this embodiment in one or more ways. For example, the authentication of a user may trigger a timer that allows the user free access for a given number of minutes, after which the user is automatically re-directed to the original non-authenticated page, or “login page”, where the user may now enter credentials or leave the computer terminal or other GUI such as a mobile phone. Upon clicking on the original advertisement and during the time allotted, the user, in this example, may be free to click on available links on the advertiser's content or “landing” page, to complete a purchase on an e-commerce site.

An alternate method for limiting access to the advertiser's content and not allowing the user to access the internet for free through the Operator's Network, is to limit the number of “clicks” (or http requests) that a particular user can initiate. In this case, the authentication of each user triggers a counter that allows the user free access until a given number of clicks have been initiated, after which the user is automatically re-directed to the original non-authenticated page, or “login page”, where the user may enter the credentials or leave the GUI. Upon clicking on the original advertisement, the user may be free to click on available links on the advertiser's content or “landing” page to complete a purchase on an e-commerce site, until the given number of clicks has been reached. Other possible limitations on internet access have been mentioned above, and still others may be understood by those skilled in the art.

In another embodiment, any two or more methods, for example the two described above, can be used to limit the effects of implicit authentication in combination. For example a user can be authenticated for 4 minutes and a maximum of 10 clicks. If the user clicks 10 times within 2 minutes, then the user may be re-directed to the original pre-authenticated page at the 11^{th} click. Alternatively, the user may be allowed access until both four minutes and 10 clicks are up, or until four minutes after the tenth click, or various other possible limitations.

### Dynamic Walled-Garden

Another alternative is to manage entries in a network operator's walled-garden automatically using services provided by a content platform. The platform may determine, for each access point, a set of domains that are currently active for serving pre-authenticated content and passes this white-list to the access point. The access point either pulls, or the platform pushes, updates to the white-list.

Referring to FIG. 4, outside of a workflow for publishing content to users, an access point 43 may receive a list of “white-listed” domains from a content platform 41 that are valid for serving content. The content may be served from a traditional content server 42. The Access Point 43 allows the request as the domain of content server 42 is explicitly allowed in the dynamically populated Walled-garden of the Network Operator. A User Device 44 receives the published content.

An advertising campaign may be configured on the content platform 41. The campaign may include displaying an advertisement on a user device 44 connected to an access point 43, with the ability for the user to click on the ad and activate a link. Upon clicking on the link, another web page with additional promotional content from the advertiser is displayed on the user device 44. Each of the following URLs below represents a particular type of function in the delivery of the advertising campaign. All the URL types below must be retrievable by the user device in order to achieve the objectives of the campaign.

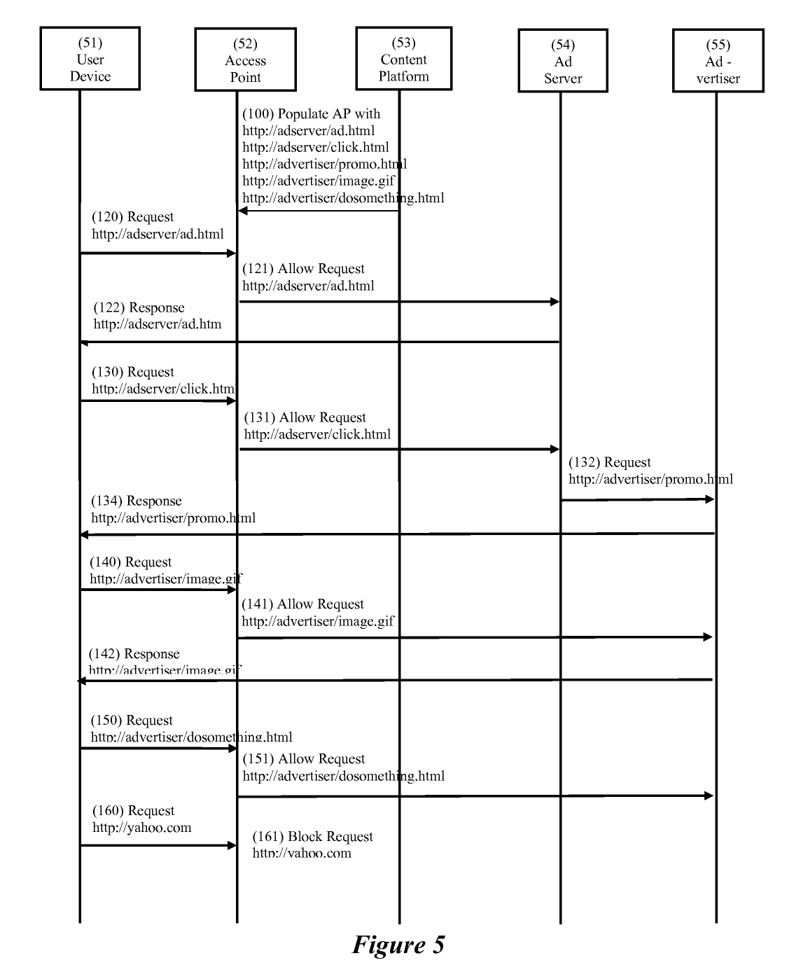

Referring now to FIG. 5, interactions between a user device 51, an access point 52, a content platform 53, an ad server 54 and an advertiser web site 55 are described in an exemplary embodiment of a process involving a dynamic walled garden in accordance with certain embodiments.

An access point 52 is populated by a content platform 53 with the five http request items shown at a first step 110. A user device 51 then requests at step 120 an http://adserver/ad.html at the access point 52. This http item is a display advertisement that is first shown on the user device 51 in this example. The http://adserver/ad.html request is allowed to be sent to the ad server 54 by the access point 51 at step 121. The response is sent at 122 by ad server 54 to user device 51, including the http://adserver/ad.html object.

At step 130, a request is sent by user device 51 to access point 52 for http://adserver/click.html. This http item is a link that allows a display advertisement to be clicked and then shows more information pertaining to the advertisement (or other content). The request is allowed by the access point 52 at step 131 to be sent to ad server 54. Ad server 54 sends a request for http://advertiser/promo.html to advertiser web site 55 at step 132. This http item is a ‘landing page’ which is a web page to be rendered on a user device 51 after a user clicks on a display advertisement. A response is sent to the user device 51 from the advertiser 55 at step 134 including the http://advertiser/promo.html promo page.

At step 140, the user device 51 may request http://advertiser/image.gif from the access point which allows the request at 141 to be sent to the advertiser site 55. This http item is an embedded image on the ‘landing page’ that is also allowed to be rendered by the walled-garden. In response, the advertiser site 55 send a response at 142 to the user device 51 including the http://advertiser/image.gif image.

At step 150, the user device 51 requests http://advertiser/dosomething.html from the access point 52. This http item may be a link on the ‘landing page’ which allows the user device 51 to interact with an advertising promotion. This request is allowed at 151 to be sent to the advertiser web site 55, and the interaction takes place.

At step 160, a user who has been pre-authenticated only within the dynamic walled garden in accordance with these several embodiments requests http://yahoo.com, but that request is blocked at 161, because no content platform 53 populated the access point 52 with the yahoo site.

The content platform 53 determines, either manually or dynamically, the specific links corresponding to the above link types that are to be white-listed for a campaign that it is responsible for. The content platform 53 provides this information to the access point 52. The information could be ‘pushed’ to the access point 52 by the content platform 53, or the access point 52 could ‘pull’ the information from the content platform 53.

The result is such that when a user device 51 interacts with an advertisement, the dynamic walled-garden allows the interaction to continue within the confines of the advertising campaign, while still preventing access to links that are restricted by the access point 52 because the user device 51 has not yet been authenticated to access the Internet at large.

There may be many URLs of the types above that can be configured for each campaign. It is advantageously greatly scalable and less error prone to achieve this functionality via a dynamic walled-garden which updates on the-the-fly the “allowed” links.

All references, web pages, web addresses and http addresses cited above, as well as the background and summary of the invention, are hereby incorporated by reference into the detailed description as providing alternative embodiments.

In addition, the following are hereby incorporated by reference:
US published applications nos. 2007/067969, 2007/0260531, 2007/0260741, 2004/0209602, 2003/0135581 and PCT/US2007/067966; and
U.S. Pat. Nos. 6,487,538, 6,553,310, 6,983,313, 5,948,061, 6,795,700, 6,798,358, 6,799,032, 6,832,373, 6,845,400, 6,848,542, 6,819,267, 5,835,061, 5,969,678, 6,259,405, 6,326,918, 6,452,498, 6,697,018, 6,759,960, 7,039,599, 5,937,392, 6,119,098, 6,990,462, 5,740,549, 6,920,464, 7,328,266 and 7,009,556; and

U.S. patent applications Ser. Nos. 10/886,502, 60/746,209, 60/913,451, 60/913,444 and 60/746,216 which are by the same inventor as the present application, and

The following web sites: www.placecast.net, www.1020systems.com, www.1020.com, www.freefinet.com, www.wifinder.com, and www.wi-fiplanet.com

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

What is claimed is:

1. A method of dynamic pre-authentication, comprising:
(a) receiving at an access point from one or more content platforms a white-list of internet domains that are to be deemed valid for serving content to a non-authenticated user;
(b) dynamically receiving updates to the white list from said one or more content platforms which are each responsible for a particular promotional campaign that features specific content;
(c) receiving a request at said access point from a non-authenticated user for certain of said specific content; and
(d) allowing the non-authenticated user to retrieve a domain of the content platform responsible for said certain specific content.

2. The method of claim 1, wherein the request is for ad content available via an Ad Server, and wherein a response is provided to the user from the Ad Server including the ad content.

3. The method of claim 2, further comprising receiving and allowing a click request from the user in regard to the ad content, wherein a response page is provided to the user based on requests to the Ad Server and to an Advertiser responsible for the response page.

4. The method of claim 3, further comprising receiving and allowing a request for an embedded image on the response page, wherein the embedded image is provided to the user based on a request to the Advertiser.

5. The method of claim 3, further comprising receiving and allowing a request for a link allowing user interaction at the Advertiser.

6. A method of implicit pre-authentication, comprising:
(a) providing to an internet access point a white-list of internet domains that are to be deemed valid for serving content to a non-authenticated user requesting access;
(b) providing a protocol of curtailed internet access for a non-authenticated user requesting access to a domain that is on the white list;
(c) receiving a request at said access point from a non-authenticated user for a domain that is on the white list; and
(d) allowing the non-authenticated user to have curtailed internet access according to the protocol at least in order to retrieve the white-listed domain.

7. The method of claim 6, wherein the protocol comprises a limited temporal duration within which the allowed internet access of the non-authenticated user is constrained.

8. The method of claim 7, wherein the protocol further comprises a limited number of http requests, such that the non-authenticated user is constrained both to said limited temporal duration and said limited number of http requests.

9. The method of claim 6, wherein the protocol comprises a limited number of http requests.

10. The method of claim 6, wherein the protocol comprises a limited amount of downloading of content.

11. The method of claim 6, wherein the protocol comprises a limited quantity of interaction with one or more other users.

12. The method of claim 6, wherein the protocol comprises a limited amount of streaming of content.

13. One or more computer readable media having digital code embedded therein for programming one or more processors to perform a method of dynamic pre-authentication, wherein the method comprises:
(a) receiving at an access point from one or more content platforms a white-list of internet domains that are to be deemed valid for serving content to a non-authenticated user;
(b) dynamically receiving updates to the white list from said one or more content platforms which are each responsible for a particular promotional campaign that features specific content;
(c) receiving a request at said access point from a non-authenticated user for certain of said specific content; and
(d) allowing the non-authenticated user to retrieve a domain of the content platform responsible for said certain specific content.

14. The one or more computer-readable media of claim 13, wherein the request is for ad content available via an Ad Server, and wherein a response is provided to the user from the Ad Server including the ad content.

15. The one or more computer-readable media of claim 14, further comprising receiving and allowing a click request from the user in regard to the ad content, wherein a response page is provided to the user based on requests to the Ad Server and to an Advertiser responsible for the response page.

16. The one or more computer-readable media of claim 15, further comprising receiving and allowing a request for an embedded image on the response page, wherein the embedded image is provided to the user based on a request to the Advertiser.

17. The one or more computer-readable media of claim 15, further comprising receiving and allowing a request for a link allowing user interaction at the Advertiser.

18. One or more computer readable media having digital code embedded therein for programming one or more processors to perform a method of implicit pre-authentication, comprising:
(a) providing to an internet access point a white-list of internet domains that are to be deemed valid for serving content to a non-authenticated user requesting access;
(b) providing a protocol of curtailed internet access for a non-authenticated user requesting access to a domain that is on the white list;
(c) receiving a request at said access point from a non-authenticated user for a domain that is on the white list; and
(d) allowing the non-authenticated user to have curtailed internet access according to the protocol at least in order to retrieve the white-listed domain.

19. The one or more computer-readable media of claim 18, wherein the protocol comprises a limited temporal duration within which the allowed internet access of the non-authenticated user is constrained.

20. The one or more computer-readable media of claim 19, wherein the protocol further comprises a limited number of http requests, such that the non-authenticated user is constrained both to said limited temporal duration and said limited number of http requests.

21. The one or more computer-readable media of claim 18, wherein the protocol comprises a limited number of http requests.

22. The one or more computer-readable media of claim 18, wherein the protocol comprises a limited amount of downloading of content.

23. The one or more computer-readable media of claim 18, wherein the protocol comprises a limited quantity of interaction with one or more other users.

24. The one or more computer-readable media of claim 18, wherein the protocol comprises a limited amount of streaming of content.
